(19) United States
(12) Patent Application Publication
(10) Pub. No.: US 2009/0133662 A1
(43) Pub. Date: May 28, 2009

(54) Method for Operating an Internal Combustion Engine having a plurality of cylinder banks

(76) Inventors: Dirk Hartmann, Stuttgart (DE); Richard Hotzel, Stuttgart (DE); Magnus Labbe, Moeglingen (DE); Ingo Fecht, Ludwigsburg (DE)

Correspondence Address: KENYON & KENYON LLP, ONE BROADWAY, NEW YORK, NY, 10004, US

(21) Appl. No.: 11/885,857

(22) PCT Filed: Feb. 17, 2006
(86) PCT No.: PCT/EP06/60053

§ 371 Date: May 13, 2008

(30) Foreign Application Priority Data
Mar. 9, 2005 (DE) 10 2005 010 791.5

(51) Int. Cl. F02D 17/02

(52) U.S. Cl. 123/198 DC

(57) ABSTRACT

A method is provided for operating an internal combustion engine having a plurality of cylinder banks, of which at least one first cylinder bank is able to be deactivated. At least one cylinder of the first cylinder bank is intermittently activated again during the deactivation of the first cylinder bank.

### FIELD OF THE INVENTION

The present invention is based on a method for operating an internal combustion engine having a plurality of cylinder banks.

### BACKGROUND INFORMATION

Methods for operating an internal combustion engine having a plurality of cylinder banks, of which at least one first cylinder bank can be switched off, are already known. In conventional concepts a constant time interval between successive firings of the cylinders of an engine ensures that that engine will run smoothly. In so-called half-engine operation, half of the cylinders of the engine are deactivated by blocking the intake and discharge valves as well as the injection. To ensure smooth engine operation, every second cylinder in the firing order provided for normal operation with firing of all cylinders is deactivated or fired, respectively. If an entire engine or cylinder bank to which a separate exhaust tract is assigned is deactivated in such a manner, this exhaust tract is operated without mass flow. This allows the exhaust tract assigned to the deactivated engine or cylinder bank to cool off until a temperature has been reached that is critical for the operation of a catalytic converter in this exhaust tract. Furthermore, the spark plugs of the deactivated engine or cylinder bank could coke up or be contaminated by the aspiration of oil mist from the crankshaft housing.

### SUMMARY OF THE INVENTION

In contrast, the method according to the present invention for operating an internal combustion engine with a plurality of cylinder banks, having the features of the main claim, offers the advantage that during the deactivation of the first cylinder bank at least one cylinder of the first cylinder bank is activated again. This ensures that the temperature in the exhaust tract of the deactivated cylinder bank will be maintained above the temperature that is critical for a catalytic converter possibly operating in this exhaust tract. The effect of the catalytic converter in the exhaust tract of the deactivated cylinder bank will therefore not be adversely affected.

Because of the lower cooling of the temperature in the exhaust tract of the deactivated first cylinder bank, the need to switch over to full-engine operation for the activation of all cylinder banks is reduced, thereby making it possible to extend the duration for the operating type of the internal combustion engine with deactivation of the first cylinder bank. Furthermore, the reactivation of the at least one cylinder of the deactivated first cylinder bank maintains an overpressure in the combustion chamber of the first cylinder bank, so that, for instance, the aspiration of oil mist from the crankshaft housing and thus contamination of the spark plugs of the deactivated first cylinder bank is avoided. The reduced drop in the temperature in the deactivated first cylinder bank also prevents stress cracks in the engine block.

The measures set forth and described herein make possible advantageous further developments and improvements of the method indicated and described herein.

It is especially advantageous if a first firing order is specified in such a way that, in normal operation without deactivation of one cylinder bank, the cylinder banks are fired in alternation and that this firing order be maintained during the deactivation of the first cylinder bank, but that the firing be suppressed for the not activated cylinders of the deactivated first cylinder bank. This ensures smooth running of the engine even when the first cylinder bank is deactivated.

Another advantage results if the contribution for an output variable of the internal combustion engine supplied by at least one of the cylinders of the not deactivated cylinder bank is reduced, this cylinder being fired, in particular, directly prior to or following the firing of the of reactivated cylinder of the deactivated first cylinder bank. This will prevent that the output variable of the internal combustion engine is increased unintentionally by the reactivation of the at least one cylinder of the deactivated first cylinder bank.

It is especially advantageous if the reduction in the contribution for the output variable is selected in such a way that it compensates for an additional contribution for the output variable by the reactivated cylinder of the deactivated first cylinder bank. This ensures that the output variable of the internal combustion engine remains constant even in a reactivation of the at least one cylinder of the first cylinder bank. The internal combustion engine may thus continue to be operated without any loss in comfort even if the at least one cylinder of the first cylinder bank is activated again. This is particularly advantageous if the internal combustion engine is driving a vehicle. In this case the driver will not be aware of the reactivation of the at least one cylinder of the deactivated first cylinder bank.

Another advantage results if the contribution of the reactivated cylinder of the deactivated first cylinder bank for the output variable is reduced in comparison with the contribution of a cylinder of a not deactivated cylinder bank for the output variable. This makes it possible to limit as much as possible the extent of the described compensatory measure, which usually manifests itself in higher fuel consumption and poorer exhaust gas.

The reduction of the contribution for the output variable may be achieved in an especially simple manner by an ignition retard and/or by leaning of the air/fuel mixture ratio.

An even smoother engine operation is able to be adjusted if during the deactivation of the first cylinder bank a plurality of cylinders of the first cylinder bank is activated again, in particular in alternation. In addition, this makes it even easier to maintain the overpressure in the combustion chamber.

An exemplary embodiment of the present invention is represented in the drawing and explained in greater detail in the following description.

### BRIEF DESCRIPTION OF THE DRAWINGS

FIG. 1 shows a schematic view of an internal combustion engine

FIGS. 2a, 2b, 2c and 2d show various time characteristics of the torque contributions of the individual cylinders of the internal combustion engine in different operating phases of the internal combustion engine.

FIG. 3 shows a flow chart to elucidate an exemplary sequence of the method of the present invention.

### DETAILED DESCRIPTION

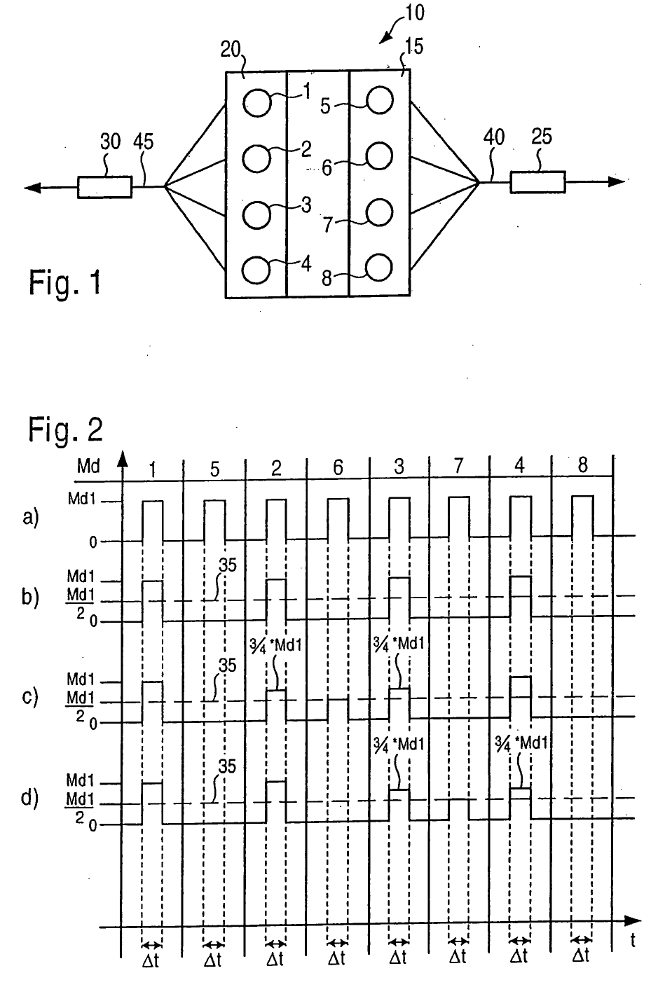

In FIG. 1, 10 designates an internal combustion engine, which is able to drive a motor vehicle, for instance. Internal combustion engine 10 is configured as Otto engine by way of example. According to FIG. 1, Otto engine 10 is realized as V8 engine having a first engine or cylinder bank 15 and a second engine or cylinder bank 20. Second cylinder bank 20 includes a first cylinder 1, a second cylinder 2, a third cylinder 3, and a fourth cylinder 4. First cylinder bank 15 includes a fifth cylinder 5, a sixth cylinder 6, a seventh cylinder 7, and an eighth cylinder 8. Cylinders 5, 6, 7, 8 of first cylinder bank 15 are assigned a first shared exhaust tract 40, in which a first catalyst 25 is disposed. Cylinders 1, 2, 3, 4 of second cylinder bank 20 are assigned a second shared exhaust tract 45, in which a second catalyst 30 is situated. In the example according to FIG. 1 all cylinders 1, 2, 3, 4, 5, 6, 7, 8 are to have the same charge during normal operation described in the following text, and thus supply the same contribution for an output variable of the internal combustion engine, e.g., a torque or an output or a variable derived therefrom. In this context, by way of example, a torque is to be selected as output variable of internal combustion engine 10.

FIGS. 2a) through 2d) show various time characteristics of the torque contribution of individual cylinders 1, 2, 3, . . . , 8 of internal combustion engine 10 in different operating phases of internal combustion engine 10. FIG. 2a), for example, illustrates the time characteristic of the torque contributions of individual cylinders 1, 2, 3, . . . , 8 of internal combustion engine 10 during normal operation without deactivation of one cylinder bank 15, 20. In this example according to FIGS. 2a) through 2d), the following firing order was selected: first cylinder 1, fifth cylinder 5, second cylinder 2, sixth cylinder 6, third cylinder 3, seventh cylinder 7, fourth cylinder 4, eighth cylinder 8.

This firing order is also plotted in FIGS. 2a) through 2d). During normal operation of internal combustion engine 10 according to FIG. 2a), each cylinder 1, 2, 3, . . . , 8 in the described firing order makes the same torque contribution Md1 for the same individual time period Δt. The described firing order is specified in such a way that cylinder banks 15, 20 are fired in alternation during normal operation without deactivation of one cylinder bank 15, 20 according to FIG. 2a). This means that one cylinder of second cylinder bank 20 and one cylinder of first cylinder bank 15 is fired in alternation.

According to FIG. 2b), the time characteristic of the torque contributions of cylinders 1, 2, 3, . . . , 8 of internal combustion engine 10 is shown for an operating phase of internal combustion engine 10 in which one of the two cylinder banks 15, 20—in the present case, first cylinder bank 15—is deactivated completely. This operating phase is also known as half-engine operation. The deactivation of the cylinders of first cylinder bank 15 is accomplished by blocking the intake and discharge valves of all cylinders of first cylinder bank 15, for example, and by deactivating the injection of fuel into all cylinders of first cylinder bank 15. The cylinders of first cylinder bank 15 are then no longer fired either. Because of the specified firing order every second of the firings provided by the specified firing order is skipped, and only every second cylinder is fired in accordance with the specified firing order. This achieves smooth running of the engine even when all cylinders of first cylinder bank 15 are deactivated.

According to the operating phase shown in FIG. 2b), only cylinders 1, 2, 3, 4 of second cylinder bank 20 provide torque contribution Md1 for time period Δt. Thus, internal combustion engine 10 delivers a constant overall torque both during normal operation according to FIG. 2a) and also in the operating phase according to FIG. 2b), the overall torque resulting from the addition of the torque contributions of the fired or fueled cylinders of internal combustion engine 10 over particular time periods Δt. The overall torque of internal combustion engine 10 achieved in the operating phase according to FIG. 2b) is halved in comparison with the overall torque of internal combustion engine 10 during normal operation according to FIG. 2a). The deactivation of first cylinder bank 15 in the operating phase illustrated in FIG. 2b) therefore leads to the same overall torque of internal combustion engine 10 as if internal combustion engine 10 was operated in normal operation according to FIG. 2a), but the torque contributions of the individual cylinders 1, 2, 3, 8 for individual time period Δt would amount to only to Md1/2 instead of Md1. This is indicated by dashed line 35 in FIG. 2b).

FIG. 2c) now shows a time characteristic of the torque contributions of cylinders 1, 2, 3, . . . , 8 of internal combustion engine 10 in an operating phase of internal combustion engine 10 according to the exemplary embodiments and/or exemplary methods of the present invention. Here, first cylinder bank 15 continues to be deactivated. However, despite the general deactivation of first cylinder bank 15, sixth cylinder 6 is activated again in order to contribute to the torque. This prevents the temperature in first exhaust tract 40 from dropping below a temperature that is critical for first catalyst 25 and at which the catalytic effect would be restricted. Furthermore, the reactivation of sixth cylinder 6 maintains an overpressure in the combustion chamber of first cylinder bank 15, thereby preventing, for instance, the aspiration of oil mist from the crankshaft housing of internal combustion engine 10 and the resulting contamination of the spark plugs of cylinders 5, 6, 7, 8 of first cylinder bank 15. The temperature in first cylinder bank 15, which has increased due to the reactivation of sixth cylinder 6 in comparison with the complete deactivation of first cylinder bank 15, also makes it possible to avoid stress cracks in the engine block of the internal combustion engine.

The renewed activation of sixth cylinder 6 of the otherwise deactivated first cylinder bank 15 leads to an additional torque contribution, without this being attributable to a driver command. To prevent a rise in the overall torque of internal combustion engine 10 beyond the value input by the driver therefore requires a reduction in the torque contribution of at least one cylinder of the not deactivated second cylinder bank 20. In the example according to FIG. 2c), the torque contribution of second cylinder 2 and the torque contribution of third cylinder 3 were reduced. As an alternative, it would also have been possible to reduce only the torque contribution of a single cylinder of the not deactivated second cylinder bank 20. As an additional alternative, the torque contributions of more than two cylinders of the not deactivated second cylinder bank 20 could have been reduced.

Instead of second cylinder 2 and third cylinder 3, first cylinder 1 and/or fourth cylinder 4 also could have been used to reduce the torque contribution. However, to achieve the smoothest engine operation possible, it is advantageous to reduce the torque contribution of at least one of the cylinders fired immediately prior to or following the firing of the reactivated cylinder—here, sixth cylinder 6 of deactivated first cylinder bank 15. In the example of FIG. 2c), second cylinder 2 and third cylinder 3 were therefore selected for the reduction of the torque contribution since second cylinder 2 is fired immediately prior to sixth cylinder 6 in the specified firing order, and third cylinder 3 is fired immediately following sixth cylinder 6 in the specified ignition order.

If the additional torque contribution of reactivated sixth cylinder 6 of deactivated first cylinder bank 15 is to be compensated for in full, then the surface area of the reduced torque contribution of second cylinder 2 and third cylinder 3 according to FIG. 2c) over the respective time period Δt must correspond precisely to the surface area of the additional torque contribution of sixth cylinder 6 over time period Δt. This is achieved by reducing the torque contributions of second cylinder 2 and third cylinder 3 to, for instance, the value of ¾*Md1 in each case. In this context it is not mandatory that the two cylinders 2, 3 are reduced to the same torque contribution; decisive is that, as described, the surface area of the additional torque contribution of sixth cylinder 6 over time period Δt is compensated for in full by the reduction of the torque contribution of the at least one cylinder of not deactivated second cylinder bank 20—in the example at hand, the two cylinders 2, 3.

To keep the compensatory measures to a minimum, it is advantageous to keep the additional torque contribution of the fueled cylinder of the otherwise deactivated first cylinder bank 15 as low as possible as well. Reducing the torque contribution of the at least one cylinder of the not deactivated second cylinder bank 20 and keeping the torque contribution of the fueled cylinder of the otherwise deactivated first cylinder bank 15 to a minimum may both be achieved by, for example, retarding the firing angle of the corresponding cylinders, and/or by leaning the air/fuel mixture ratio in the particular cylinders. It is particularly advantageous in this context if the torque contribution of the reactivated sixth cylinder 6 of the otherwise deactivated first cylinder bank 15 is reduced in comparison with the torque contribution of one or a plurality of cylinder(s) of the not deactivated second cylinder bank 20. In the exemplary embodiment according to FIG. 2c), the torque contribution of sixth cylinder 6, at Md1/2, is smaller than any of the torque contributions of cylinders 1, 2, 3, 4 of the not deactivated second cylinder bank 20. The torque contribution of first cylinder 1 and fourth cylinder 4 during the particular time period Δt is equal to Md1 in each case, and the torque contribution of second cylinder 2 and third cylinder 3 over time period Δt amounts to ¾*Md1 in each case.

In FIG. 2c) as well, line 35 is plotted at Md1/2 as average value of all torque contributions across the entire illustrated firing order period.

Instead of sixth cylinder 6, it is also possible to reactivate a different cylinder of first cylinder bank 15 during the deactivation of first cylinder bank 15. According to the exemplary embodiment of FIG. 2d), this is seventh cylinder 7, which is providing a torque contribution of Md1/2 for time period Δt. The remaining cylinders of first cylinder bank 15 are deactivated according to the example of FIG. 2d) and do not fire. Third cylinder 3, fired immediately prior to the seventh cylinder in the firing order, and fourth cylinder 4, fired immediately following seventh cylinder 7 in the specified firing order, each provide a torque contribution of ¾*Md1 for time period Δt in the exemplary embodiment according to FIG. 2d). In the example according to FIG. 2d), the individual torque contributions of first cylinder 1 and second cylinder 2 for time duration Δt amount to Md1. In FIG. 2d) as well, line 35 is plotted at Md1/2 as average value of all torque contributions over the entire illustrated firing order period.

Thus, the functional principle of the exemplary embodiments and/or exemplary methods of the present invention according to the exemplary embodiment of FIG. 2c) is realized in an identical manner in the exemplary embodiment of FIG. 2d) and merely shifted by two cylinders in the specified firing order. Analogously, it is also possible to select fifth cylinder 5 or eighth cylinder 8 for activation given an otherwise deactivated first cylinder bank 15. It is likewise possible to select for reactivation more than one cylinder of first cylinder bank 15 given an otherwise deactivated first cylinder bank 15. In this context, as described, the immediately adjacent cylinders in the specified firing order may be reduced in their torque contribution, which may be in order to fully compensate for the additional torque contribution of the activated cylinders of otherwise deactivated first cylinder bank 15. In a corresponding manner, it is possible to see to it that the torque contributions of the activated cylinders of otherwise deactivated first cylinder bank 15 are selected smaller than the torque contribution of each cylinder of the not deactivated second cylinder bank 20.

Line 35 in the exemplary embodiments according to FIGS. 2b), 2c) and 2d) represents the, on average, constant torque contribution of the activated cylinders of internal combustion engine 10 that leads to smooth engine operation.

The torque contribution of the reactivated cylinder of otherwise deactivated first cylinder bank 15 need not necessarily be smaller than the torque contribution of each cylinder of the not deactivated second cylinder bank 20; however, the torque contribution of the reactivated cylinder of otherwise deactivated first cylinder bank 15 increases the effort required to compensate for this amount. It is therefore advantageous if the torque contribution of the at least one reactivated cylinder of otherwise deactivated first cylinder bank 15 is reduced in comparison with the torque contribution of at least one cylinder of not deactivated second cylinder bank 20.

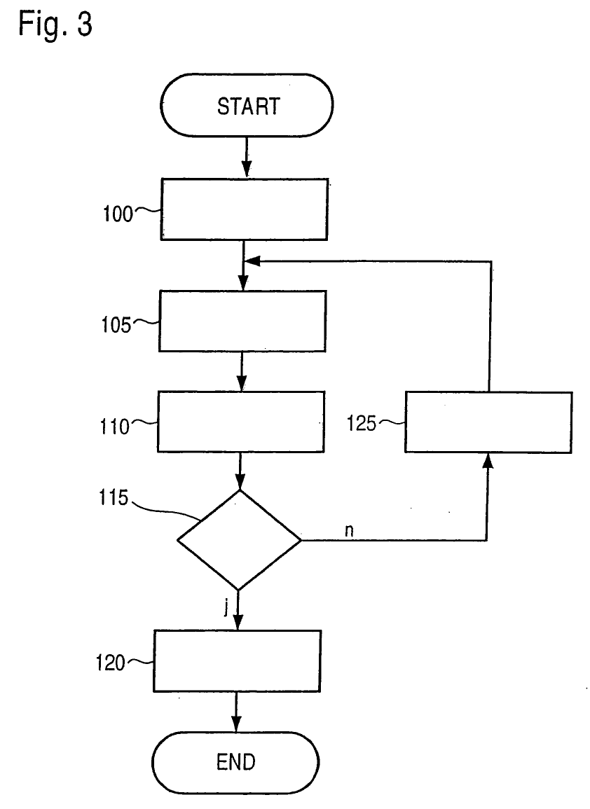

FIG. 3 shows a flow chart of an exemplary sequence of the method according to the present invention. After starting the program, a controller (not shown in FIG. 1) of internal combustion engine 10 completely deactivates first cylinder bank 15 in a program point 100, i.e., all cylinders 5, 6, 7, 8 of first cylinder bank 15 are switched off and no longer fire. Branching to a program point 105 then takes place.

In program point 105, the controller initiates the activation of one cylinder of otherwise deactivated first cylinder bank 15, e.g., sixth cylinder 6, so that it is again supplied with fuel and fires. However, in so doing the controller adjusts the ignition angle and/or the air/fuel mixture ratio of this reactivated cylinder of otherwise deactivated first cylinder bank 15 in such a way that the torque contribution of this cylinder is lower than the torque contribution of each cylinder of the not deactivated first cylinder bank 20. In the process, the controller adjusts the ignition angle, for example, and/or the air/fuel mixture ratio of this reactivated cylinder of the otherwise deactivated first cylinder bank 15 in such a way that its torque contribution is half as large as the maximum torque contribution of the cylinders of the not deactivated second cylinder bank 20. Branching to a program point 110 then takes place.

In program point 110, the controller of internal combustion engine 10 initiates a reduction in the torque contribution of the particular cylinders of the not deactivated second cylinder bank 20 that are directly adjacent to the reactivated cylinder of the otherwise deactivated first cylinder bank 15 in the specified firing order. This reduction may also be achieved by an ignition retard and/or by leaning the air/fuel mixture of these adjacent cylinders. For example, the controller reduces the torque contributions of these adjacent cylinders in such a way that the additional torque contribution of the reactivated cylinder of otherwise deactivated first cylinder bank 15 is compensated for precisely. In the exemplary embodiment according to FIGS. 2c) and 2d), this may be achieved by reducing the torque contributions of these two adjacent cylinders by one fourth in each case. Branching to a program point 115 then takes place.

In program point 115, the controller checks whether the half-engine operation with deactivation of first cylinder bank 15 is to be terminated, for instance because a driver command has been received that cannot be realized by using one of the two cylinder banks 15, 20. If this is the case, branching to a program point 120 takes place; otherwise, branching to a program point 125 occurs.

In program point 120, the controller switches the internal combustion engine into normal operation according to FIG. 2a). To prevent any undesired torque jerk in the switchover to normal operation, which the driver would perceive as uncomfortable, the torque contributions of individual cylinders 1, 2, 3, . . . , 8 of internal combustion engine 10 for normal operation should initially be selected such that no change occurs in the overall torque in comparison with the previous half-engine operation. To this end, the torque contributions of the individual cylinders 1, 2, 3, . . . , 8 in this example could first be set to value Md1/2 immediately after the switchover to normal operation, so that the average value of the torque contributions over the firing-order period initially continues to assume the value Md1/2 according to line 35. Using a ramp function, for instance, the torque contribution of the individual cylinders may subsequently be increased during in normal operation in order to fully implement the driver command. The program will then be exited.

In program point 125, instead of the previously activated cylinder of the otherwise deactivated first cylinder bank 15, the controller may select a different cylinder of first cylinder bank 15 for the reactivation, so that a switch takes place from the specific embodiment according to FIG. 2c) to the specific embodiment according to FIG. 2d), for example, if seventh cylinder 7 instead of sixth cylinder 6 is then selected in program point 125 for the reactivation of the otherwise deactivated first cylinder bank 15. The switchover then takes place after branching back at program point 105. In the following program point 110, the cylinders of the not deactivated second cylinder bank 20 flanking the now activated cylinder of the otherwise deactivated first cylinder bank 15 in the specified firing order are then in turn reduced in their torque contribution in the manner described.

When running through the loop with program point 125 multiple times, each of the cylinders of first cylinder bank 15 may be activated again in this manner, for instance cyclically and thus in alternation, given an otherwise deactivated first cylinder bank 15. As an alternative, program point 125 may also be skipped, and direct back-branching to program point 105 may take place in the case of a no-decision in program point 115. In this case the reactivated cylinder of otherwise deactivated first cylinder bank 15 will not be changed. In program point 125, the controller also could skip the reactivation of one cylinder of the deactivated first cylinder bank 15 for the subsequent firing-order period.

The method according to the present invention also may be realized in a corresponding manner at different charges of the individual cylinders of internal combustion engine 10, and thus with different torque contributions of the individual cylinders. Smooth engine running is able to be ensured as long as a constant torque contribution is realized for the individual cylinders on average. The additional torque contribution of the reactivated cylinder or the reactivated cylinders of the otherwise deactivated first cylinder bank 15 may be compensated for correspondingly by reducing the torque contribution of, for example, the cylinders of not deactivated second cylinder bank 20 immediately adjacent to the reactivated cylinder(s) in the firing order.

According to the above exemplary embodiment, it was assumed that first cylinder bank 15 is completely deactivated in half-engine operation and that second cylinder bank 20 continues to operate in full. As an alternative, it is of course also possible that second cylinder bank 20 is completely deactivated and first cylinder bank 15 continues operating in full.

Furthermore, the method according to the present invention is not limited to the use of two cylinder banks, but also may be applied in a corresponding manner to more than two cylinder banks; according to the exemplary embodiments and/or exemplary methods of the present invention, at least one of the cylinders of the completely deactivated cylinder bank must be reactivated again during the deactivation of this cylinder bank. The described further developments and improvements of the exemplary embodiments and/or exemplary methods of the present invention, which consist of reducing the torque contribution for at least one of the cylinders of at least one not deactivated cylinder bank, which may be for the complete compensation of the additional torque contribution of the at least one reactivated cylinder of the deactivated cylinder bank, are analogously applicable to those cases where more than two cylinder banks are provided. Here, too, a firing order may be specified in which the individual cylinder banks are fired in alternation and, in particular, one or both of the cylinder(s) of the reactivated cylinder of the deactivated cylinder bank immediately adjacent in this firing order is/are reduced in its/their torque contribution. Even when using a plurality of cylinder banks, the torque contribution of the at least one reactivated cylinder of the otherwise deactivated cylinder bank may be selected smaller than the torque contribution of, in particular, each cylinder of the not deactivated cylinder banks.

When more than two cylinder banks are used, it is also possible to deactivate a plurality of cylinder banks completely and to operate at least one cylinder bank in full. The method according to the present invention may be applied in a corresponding manner to such a situation as well, notwithstanding the fact that one or several cylinders may lie between the reactivated cylinder of a deactivated cylinder bank and the cylinder of a not deactivated cylinder bank fired immediately before or afterwards, this cylinder or these cylinders likewise being part of a deactivated cylinder bank and not being supplied with fuel and fired.

1-7. (canceled)

8. A method for operating an internal combustion engine having a plurality of cylinder banks, the method comprising:
deactivating at least one first cylinder bank; and
activating again at least one cylinder of the first cylinder bank during the deactivation of the first cylinder bank.

9. The method of claim 8, wherein a firing order is specified so that in normal operation without deactivation of one cylinder bank, the cylinder banks are alternately fired, and the firing order is maintained during the deactivation of the first cylinder bank, but the firing for the unactivated cylinders of the deactivated first cylinder bank is suppressed.

10. The method of claim 8, wherein a contribution for an output variable of the internal combustion engine supplied by at least one of the cylinders of the not deactivated cylinder bank fired immediately one of prior to and following the firing of the reactivated cylinder of the deactivated first cylinder bank is reduced.

11. The method of claim 10, wherein a reduction in the contribution for the output variable is selected so that it compensates for an additional contribution for the output variable by the reactivated cylinder of the deactivated first cylinder bank.

12. The method of claim 8, wherein a contribution of the reactivated cylinder of the deactivated first cylinder bank for the output variable is reduced in comparison with a contribution of a cylinder of a not deactivated cylinder bank for the output variable.

13. The method of claim 10, wherein the contribution for the output variable is reduced by at least one of an ignition retard and by making leaner the air/fuel mixture ratio.

14. The method of claim 8, wherein a plurality of cylinders of the first cylinder bank is activated again, in alternation, during the deactivation of the first cylinder bank.
